(19) United States
(12) Patent Application Publication
(10) Pub. No.: US 2024/0190231 A1
(43) Pub. Date: Jun. 13, 2024

(54) Battery Replacement Station

(71) Applicant: TOYOTA JIDOSHA KABUSHIKI KAISHA, Toyota-shi Aichi-ken (JP)

(72) Inventors: Atsushi MIKUNI, Toyota-shi Aichi-ken (JP); Shintaro KITAKATA, Nisshin-shi Aichi-ken (JP); Reiji IWAIHARA, Toyota-shi Aichi-ken (JP); Takumi KAWATA, Okazaki-shi Aichi-ken (JP); Norihisa NOMURA, Ogaki-shi Gifu-ken (JP)

(73) Assignee: TOYOTA JIDOSHA KABUSHIKI KAISHA, Toyota-shi Aichi-ken (JP)

(21) Appl. No.: 18/514,458

(22) Filed: Nov. 20, 2023

(30) Foreign Application Priority Data
Dec. 9, 2022 (JP) 2022-197360

(51) Int. Cl. B60K 1/04; B60L 53/80

(52) U.S. Cl. CPC B60K 1/04; B60L 53/80; B60K 2001/0472

(57) ABSTRACT

A battery replacement station includes a drive device (battery replacement process unit) that performs a process of replacing a battery (first battery) with another battery (second battery), and a control device (controller) that controls the drive device. The drive device includes a raising/lowering unit (lift-up mechanism) that lifts up a vehicle body of an electrically powered vehicle, and a battery mounting table onto which a battery removed from a bottom portion of the electrically powered vehicle is to be withdrawn. The drive device also includes an operating table (angle adjustment mechanism) that adjusts a relative angle between the vehicle body in a state of being lifted up, and the battery mounting table, in a plan view as seen from above the electrically powered vehicle.

### CROSS-REFERENCE TO RELATED APPLICATIONS

This nonprovisional application is based on Japanese Patent Application No. 2022-197360 filed on Dec. 9, 2022 with the Japan Patent Office, the entire contents of which are hereby incorporated by reference.

### BACKGROUND

### Field

The present disclosure relates to a battery replacement station.

### Description of the Background Art

Japanese Patent Application Laid-Open No. 2012-192782 discloses a battery replacement apparatus that lifts up a vehicle by a raising/lowering device to make the vehicle horizontal. The battery removed from the vehicle lifted up by the raising/lowering device is retracted from the vehicle by a battery raising/lowering means which goes up and down below the vehicle.

### SUMMARY

In the battery replacement apparatus of Japanese Patent Application Laid-Open No. 2012-192782, the vehicle body may be inclined unintentionally in the case where a foreign matter is sandwiched between the vehicle body and the raising/lowering device, or the vehicle body and the lifting/lowering device are deformed, for example. In this case, the positional adjustment (angular adjustment) between the vehicle and the battery raising/lowering means (battery mounting table) is not made appropriately, which makes it difficult to replace the battery. As such, there is a demand for a battery replacement station that can perform battery replacement easily by a battery mounting table.

The present disclosure is given to solve the above problem, and an object of the present disclosure is to provide a battery replacement station that can perform battery replacement easily by a battery mounting table.

A battery replacement station according to one aspect of the present disclosure is a battery replacement station provided with a battery that is replaceable with a battery provided in a bottom portion of an electrically powered vehicle, the battery provided in the bottom portion of the electrically powered vehicle being a first battery, the battery provided in the battery replacement station being a second battery, the battery replacement station including: a battery replacement process unit that performs a process of replacing the first battery with the second battery; and a controller that controls the battery replacement process unit. The battery replacement process unit includes: a lift-up mechanism that lifts up a vehicle body of the electrically powered vehicle; a battery mounting table onto which the first battery removed from the bottom portion of the electrically powered vehicle is to be withdrawn; and an angle adjustment mechanism that adjusts a relative angle between the vehicle body in a state of being lifted up, and the battery mounting table, in a plan view as seen from above the electrically powered vehicle.

In the battery replacement station according to one aspect of the present disclosure, the relative angle between the vehicle body in the state of being lifted up and the battery mounting table in the plan view as seen from above the electrically powered vehicle is adjusted by the angle adjustment mechanism. Thus, even when the positional adjustment (angular adjustment) between the vehicle body and the battery mounting table is not made appropriately, due to unintended inclination of the vehicle body at the time the vehicle body is lifted up, the relative angle can be adjusted to thereby establish a proper positional relation (angular relation) between the vehicle body and the battery mounting table. As a result, battery replacement can be performed easily by the battery mounting table.

In some embodiments, the battery replacement station according to the above one aspect further includes a relative angle detector that detects the relative angle. The angle adjustment mechanism includes a vehicle body adjustment mechanism that adjusts an angle of the vehicle body in the plan view. The controller controls the vehicle body adjustment mechanism when the relative angle is larger than a predetermined value. With such configuration, when the relative angle is larger than a predetermined value, it is possible to easily adjust the relative angle by adjusting the angle of the vehicle body by the vehicle body adjustment mechanism.

In some embodiments, the angle adjustment mechanism includes a mounting table adjustment mechanism that adjusts an angle of the battery mounting table in the plan view. The controller controls the mounting table adjustment mechanism when the relative angle is smaller than or equal to the predetermined value. With such configuration, when the relative angle is smaller than or equal to the predetermined value, it is possible to adjust the relative angle by adjusting the angle of the battery mounting table by the mounting table adjustment mechanism, even without adjusting the angle of the vehicle body. As a result, there is no need to adjust the angle of the vehicle body having a relatively larger weight, and therefore, increase of power consumption by the battery replacement process unit can be suppressed.

In some embodiments, in the battery replacement station including the relative angle detector, the relative angle detector includes a data acquisition unit that acquires data about the angle of the vehicle body in the plan view. The data acquisition unit is installed on the battery mounting table. With such configuration, data acquired by the data acquisition unit installed on the battery mounting table can be used to easily obtain the relative angle.

In some embodiments, in the battery replacement station including the relative angle detector, the relative angle detector detects each of an angle of the vehicle body in the state of being lifted up, with respect to a predetermined direction in the plan view, and an angle of the battery mounting table with respect to the predetermined direction in the plan view. Moreover, the relative angle detector detects the relative angle by calculating a difference between the angle of the vehicle body and the angle of the battery mounting table. With such configuration, information about the angle of each of the vehicle body and the battery mounting table can be obtained, in addition to the relative angle.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a diagram showing a configuration of a battery replacement station according to a first embodiment.

FIG. 2 is a plan view showing a configuration of a vehicle stop area of the battery replacement station.

FIG. 3 is a side view showing a state in which a vehicle body is lifted up by a raising/lowering unit.

FIG. 4 is a perspective view showing a configuration of a battery mounting table of the battery replacement station.

FIG. 5 is a bottom view of the electrically powered vehicle.

FIG. 6 is a view showing a relative angle between the electrically powered vehicle and the battery mounting table according to the first embodiment.

FIG. 7 is a sequence diagram showing sequence control between the battery replacement station and the electrically powered vehicle according to the first embodiment.

FIG. 8 is a diagram showing a configuration of a battery replacement station according to a second embodiment.

FIG. 9 is a diagram showing a relative angle between the electrically powered vehicle and the battery mounting table according to the second embodiment.

FIG. 10 is a sequence diagram showing sequence control between the battery replacement station and the electrically powered vehicle according to the second embodiment.

### DESCRIPTION OF THE EMBODIMENTS

### First Embodiment

Hereinafter, a first embodiment of the present disclosure will be described in detail with reference to the drawings. In the drawings, the same components are denoted by the same reference numerals. In addition, descriptions of the same portions will not be repeated.

### (Configuration of Battery Replacement Station)

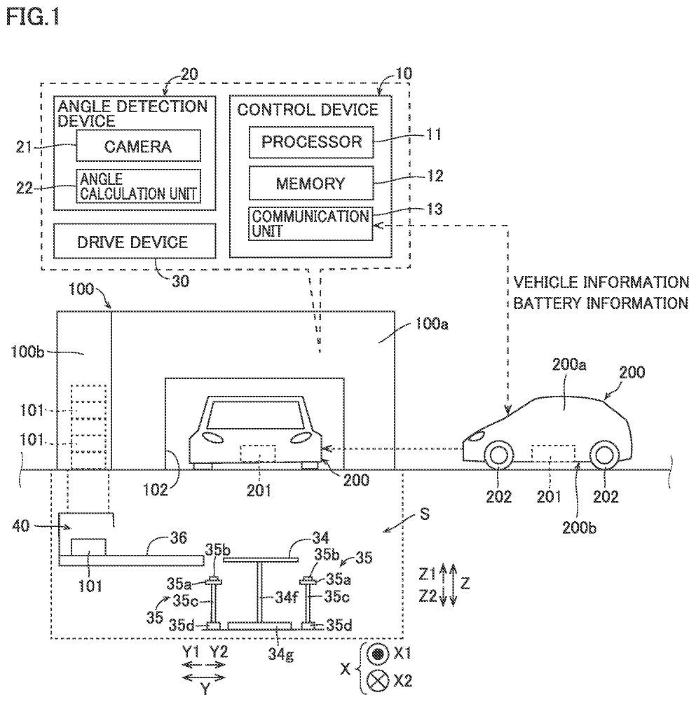

FIG. 1 is a diagram showing a configuration of a battery replacement station 100 according to a first embodiment. The battery replacement station 100 is a facility for replacing the battery 201 attached to the bottom portion 200b of the electrically powered vehicle 200 with a new battery 101. The battery replacement station 100 includes a battery replacement apparatus 100a and a storage 100b. In the battery replacement apparatus 100a, a battery replacement process is performed. A battery 101 is stored in the storage 100b. The storage 100b is provided in parallel with the battery replacement apparatus 100a. The battery replacement apparatus 100a is provided with an entrance/exit 102 for the electrically powered vehicle 200 to enter/exit. The battery 201 and the battery 101 are examples of the “first battery” and the “second battery” of the present disclosure, respectively.

In the underfloor area S of the battery replacement station 100, a battery mounting table 34, a raising/lowering unit 35, a transport unit 36, and a temporary placement site 40 are provided. The raising/lowering unit 35 can lift up the vehicle body 200a of the electrically powered vehicle 200. The raising/lowering unit 35 is an example of the “lift-up mechanism” of the present disclosure.

After the battery 101 is moved from the storage 100b to the temporary placement site 40, the battery 101 is conveyed to the electrically powered vehicle 200 by the transport unit 36.

The battery replacement station 100 includes a control device 10, an angle detection device 20, and a drive device 30. The angle detection device 20 is an example of the “relative angle detector” of the present disclosure. The control device 10 and the drive device 30 are examples of the “controller” and the “battery replacement process unit” of the present disclosure, respectively.

The control device 10 includes a processor 11, a memory 12, and a communication unit 13. The memory 12 stores, in addition to a program executed by the processor 11, information (e.g., map, formula, and various parameters) used by the program. The control device 10 (processor 11) controls the drive device 30.

The communication unit 13 includes various communication I/Fs. The processor 11 controls the communication unit 13. The communication unit 13 communicates with a DCM or the like of the electrically powered vehicle 200. The communication unit 13 and the electrically powered vehicle 200 can perform bidirectional communication. The communication unit 13 may communicate with a mobile terminal or the like possessed by the user of the electrically powered vehicle 200.

The angle detection device 20 includes a camera 21 and an angle calculation unit 22. The camera 21 is an example of the “data acquisition unit” of the present disclosure.

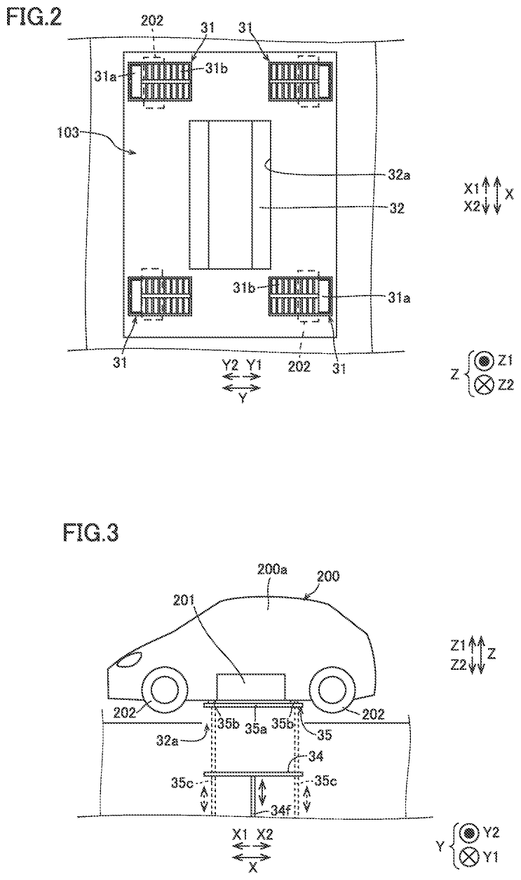

As shown in FIG. 2, the battery replacement station 100 is provided with a vehicle stop area 103. The user of the electrically powered vehicle 200 performs an operation of instructing the start of a battery replacement operation in a navigation system (not shown) of the electrically powered vehicle 200 in a state where the electrically powered vehicle 200 is stopped in the vehicle stop area 103. Thus, the instruction signal for starting the battery replacement operation is transmitted from the electrically powered vehicle 200 to the communication unit 13. The processor 11 starts control of battery replacement by the drive device 30 based on reception of the instruction signal by the communication unit 13. The electrically powered vehicle 200 is stopped in the vehicle stop area 103 such that the longitudinal direction of the vehicle body 200a is the X direction and the lateral direction of the vehicle body 200a is the Y direction.

The drive device 30 performs a process of replacing the battery 101 and the battery 201. The drive device 30 includes a wheel chock 31, a shutter 32, a battery mounting table 34 (refer to FIG. 1), a raising/lowering unit 35 (refer to FIG. 1), and a transport unit 36 (refer to FIG. 1).

Four wheel chocks 31 are provided in the vehicle stop area 103. The wheel chocks 31 are provided so as to correspond to the four wheels 202 of the electrically powered vehicle 200.

The wheel chock 31 includes a pressing member 31a and a lateral roller portion 31b. The pressing member 31a is disposed so as to straddle the lateral roller portion 31b. The pressing member 31a moves the wheel 202 by pressing the wheel 202 from the outside (side). As a result, the wheel 202 is positioned by the wheel chock 31.

The lateral roller portion 31b includes a plurality of rollers whose rotation axes extend in the X direction. The plurality of rollers of the lateral roller portion 31b are arranged in the Y direction. The pressing member 31a is moved along the Y direction by rotation of a plurality of rollers of the lateral roller portion 31b.

As shown in FIG. 3, the raising/lowering unit 35 raises and lowers the electrically powered vehicle 200, by going up and down while holding the electrically powered vehicle 200 from below. The raising/lowering unit 35 is movable in the vertical direction (Z direction) through the opening 32a.

The raising/lowering unit 35 includes a pair of raising/lowering bars 35a (see FIG. 1). Each of the pair of raising/lowering bars 35a is provided with two protrusions 35b protruding toward the Z1 side. The electrically powered vehicle 200 is supported from below by two protrusions 35b of each of the pair of raising/lowering bars 35a (i.e., four protrusions 35b).

The drive device 30 includes a pair of support portions 35c. Each of the pair of support portions 35c supports the raising/lowering bar 35a from below. When each of the pair of support portions 35c expands and contracts in the Z direction, the position of each of the pair of raising/lowering bars 35a in the Z direction varies. Each of the pair of support portions 35c is attached to an operating table 35d (see FIG. 1). The control device 10 (processor 11) controls the movement of the operating table 35d in the XY plane. Thereby, the processor 11 changes the positions of the pair of support portions 35c in the XY plane, and adjusts the angle of the vehicle body 200a lifted up by the raising/lowering unit 35 in the plan view. The mechanism for adjusting the angle of the vehicle body 200a in a plan view is not limited to the above example. The operating table 35d is an example of the “angle adjustment mechanism” and the “vehicle body adjustment mechanism” of the present disclosure.

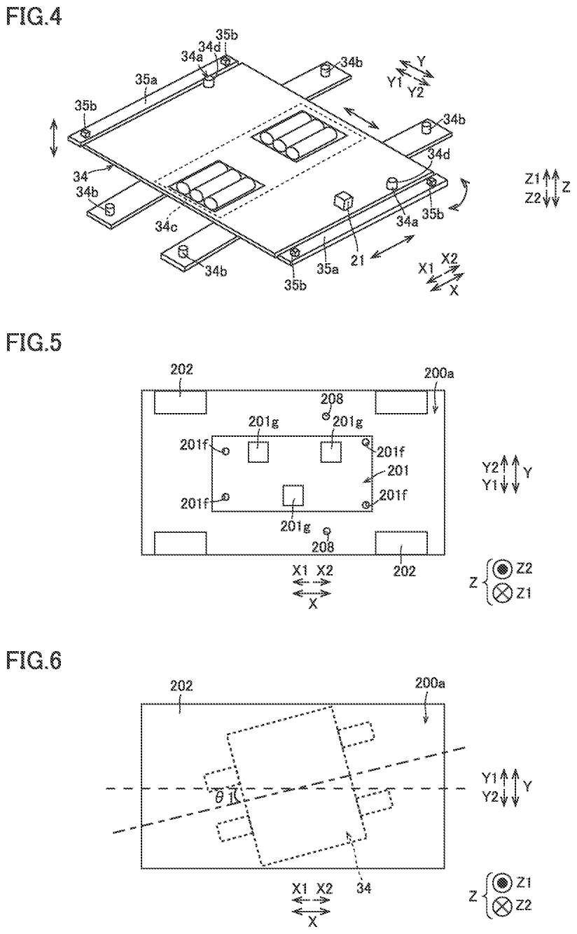

As shown in FIG. 4, the battery mounting table 34 is provided with two positioning pins 34a, four locking/unlocking tools 34b, and a roller portion 34c. A tapered surface 34d is provided at the distal end of the positioning pin 34a. That is, the positioning pin 34a has a tapered shape toward the Z1 side.

The battery mounting table 34 is configured to be movable in a horizontal direction below the electrically powered vehicle 200. Specifically, the battery mounting table 34 is movable in the X direction (X1 direction, X2 direction) and the Y direction (Y1 direction, Y2 direction). The battery mounting table 34 is rotatable so as to change the direction (angle) in the XY plane.

Specifically, the battery mounting table 34 is supported by a support portion 34f (see FIG. 1) from below (Z2 side). When the support portion 34f expands and contracts in the Z direction, the position of the battery mounting table 34 in the Z direction varies. The support portion 34f is attached to the operating table 34g. The control device 10 (processor 11) controls the movement of the operating table 34g in the XY plane. Thereby, the processor 11 changes the position of the support portion 34f in the XY plane and adjusts the angle of the battery mounting table 34 in the plan view. The mechanism for adjusting the angle of the battery mounting table 34 in a plan view is not limited to the above example. The operating table 34g is an example of the “angle adjustment mechanism” and the “mounting table adjustment mechanism” of the present disclosure.

The camera 21 is mounted on a battery mounting table 34. The camera 21 images a plurality of markers 201g (e.g., two-dimensional codes) (see FIG. 5) provided on the bottom surface of the battery 201. The angle calculation unit 22 (see FIG. 1) calculates an angle in a plan view of the vehicle body 200a in a lifted-up state based on a positional relationship or the like of the markers 201g captured by the camera 21. Since the camera 21 is installed on the battery mounting table 34, the angle of the vehicle body 200a calculated by the angle calculation unit 22 means a relative angle θ1 (see FIG. 6) in a plan view between the vehicle body 200a and the battery mounting table 34. The angle θ1 means an angle formed between the front-rear direction of the vehicle body 200a (refer to a broken line in FIG. 6) and the front-rear direction of the battery mounting table 34 (refer to a broken line in FIG. 6). The marker 201g may be provided in a portion other than the battery 201 (for example, the vehicle body 200a). The image of the marker 201g captured by the camera 21 is an example of “data relating to an angle in a plan view of the vehicle body” of the present disclosure. The angle calculation unit 22 may also calculate a relative angle between the angle of the vehicle body 200a with respect to the horizontal plane and the angle of the battery mounting table 34 with respect to the horizontal plane based on the image of the marker 201g.

Referring again to FIG. 1, the transport unit 36 is configured to be able to transport the batteries (201, 101). Specifically, the transport unit 36 transports the battery 201 mounted on the battery mounting table 34 to the temporary placement site 40. When the roller portion 34c (see FIG. 4) of the battery mounting table 34 rotates in a state where the battery mounting table 34 is lowered to the same height position (position in the Z direction) as the transport unit 36, the battery 201 mounted on the battery mounting table 34 is moved to the Y1 side and is mounted on the transport unit 36. Then, the transport unit 36 moves the battery 201 to the temporary placement site 40. The transport unit 36 may be of a belt conveyor type, for example.

Further, the transport unit 36 moves the new battery 101 transported from the storage 100b to the temporary placement site 40 to the Y2 side and places the new battery 101 on the battery mounting table 34. At this time, the roller portion 34c of the battery mounting table 34 rotates in a direction opposite to the rotation direction, whereby the battery 101 is moved to the Y2 side in the battery mounting table 34.

### (Battery Replacement Method)

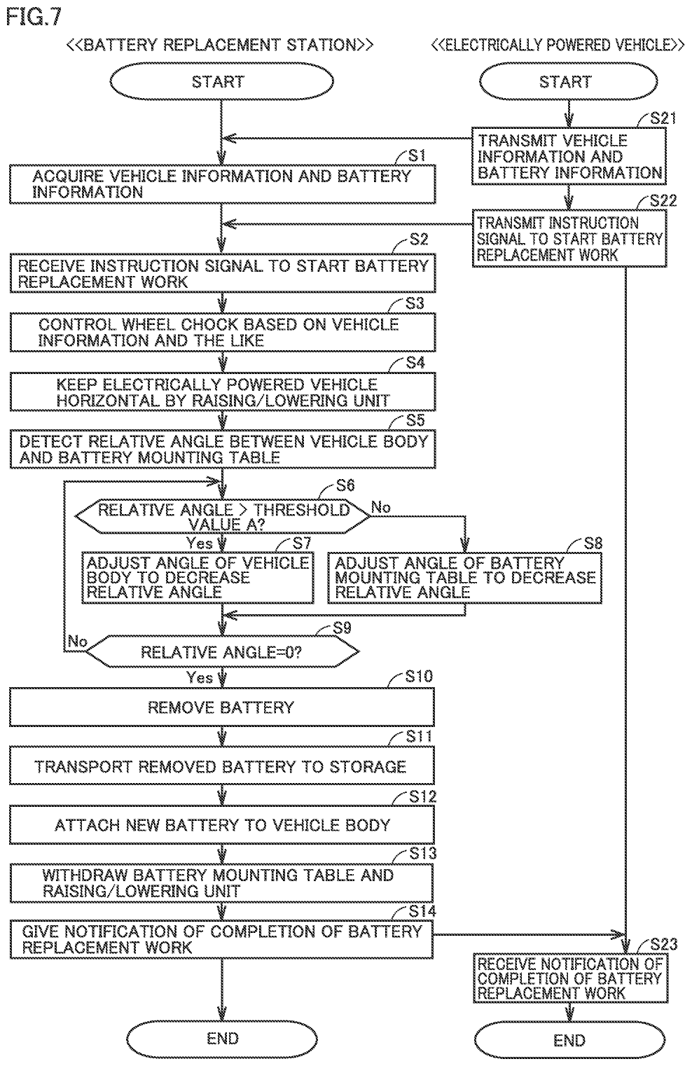

Next, a battery replacement method using the battery replacement station 100 will be described with reference to the sequence diagram of FIG. 7.

First, in step S21, the electrically powered vehicle 200 transmits information about the electrically powered vehicle 200 and information about the battery 201 to the communication unit 13 of the battery replacement station 100. For example, when an operation of transmitting the above information is performed in a navigation system (not shown) of the electrically powered vehicle 200, the above information is transmitted to the communication unit 13. Before entering the battery replacement station 100, the electrically powered vehicle 200 transmits the above information to the communication unit 13. The above information may be transmitted to the communication unit 13 after the electrically powered vehicle 200 enters the battery replacement station 100.

In step S1, the communication unit 13 of the battery replacement station 100 acquires information on the electrically powered vehicle 200 and information on the battery 201 transmitted from the electrically powered vehicle 200 in step S21 by communication. The acquired information is stored in the memory 12 (see FIG. 1).

The communication unit 13 may also acquire information on the capacity (charge capacity) of the battery 201 and the SOC (State Of Charge) of the battery 201.

In step S22, the electrically powered vehicle 200 stopped in the vehicle stop area 103 transmits an instruction signal for starting the battery replacement operation to the communication unit 13.

In step S2, the communication unit 13 receives the instruction signal transmitted from the electrically powered vehicle 200 in step S22. In step S2, after receiving the instruction signal, the processor 11 may transmit an instruction message or the like for turning off the ignition power supply to the user of the electrically powered vehicle 200 through the communication unit 13.

In step S3, the processor 11 adjusts the position of the wheel chock 31 (see FIG. 2) based on the information (vehicle information and battery information) acquired through the communication unit 13 in step S1. Note that the processor 11 may control each of the four wheel chocks 31 independently of each other.

Thus, the position and orientation of the vehicle body 200a in the horizontal direction are adjusted. Further, the position and orientation of the battery 201 in the horizontal direction are adjusted. As a result, the battery 201 can be moved to a predetermined position above the opening 32a.

In step S4, the processor 11 opens the shutter 32. Further, the processor 11 raises the raising/lowering bar 35a with the shutter 32 in the open state. Thus, the raising/lowering bar 35a passes through the opening 32a. As a result, the electrically powered vehicle 200 is lifted by the raising/lowering bar 35a (see FIG. 3). When the vehicle body 200a held by the raising/lowering bar 35a is inclined with respect to the horizontal plane, the processor 11 may adjust the height of the raising/lowering bar 35a so that the vehicle body 200a is parallel to the horizontal plane.

In step S5, the angle detection device 20 (see FIG. 1) detects a relative angle θ1 (see FIG. 6) in a plan view between the vehicle body 200a and the battery mounting table 34.

In step S6, the processor 11 determines whether or not the relative angle θ1 detected in step S5 is larger than a threshold value A (for example, 10 degrees). When the angle θ1 is larger than the threshold value A, the process proceeds to step S7. When the angle θ1 is equal to or smaller than the threshold value A, the process proceeds to step S8. The threshold value A is an example of the “predetermined value” of the present disclosure.

In step S7, the processor 11 adjusts the angle of the vehicle body 200a in a plan view so that the angle θ1 becomes smaller. Specifically, the processor 11 moves (rotates) the operating table 35d (see FIG. 1) to which the pair of support portions 35c is attached. In step S7, the processor 11 executes control to move (rotate) the operating table 35d for a predetermined time (for example, 10 seconds). In step S7, the angle of the battery mounting table 34 in a plan view is not adjusted.

In step S8, the processor 11 adjusts the angle of the battery mounting table 34 in a plan view so that the angle θ1 becomes smaller. Specifically, the processor 11 moves (rotates) the operating table 34g (see FIG. 1) to which the support portion 34f is attached. In step S8, the processor 11 executes control for moving the operating table 34g for a predetermined time (for example, 10 seconds). The final value of the angle of the battery mounting table 34 in a plan view may be stored in the memory 12. In step S8, the angle of the vehicle body 200a in a plan view is not adjusted.

In step S9, the processor 11 determines whether or not the angle θ1 after the processing in step S7 or S8 is 0. When the angle θ1 is 0, the process proceeds to step $10. When the angle θ1 is not 0, the process returns to step S6. The angle θ1 of 0 means that the angle θ1 falls within a predetermined range centered on 0 (for example, a range of 0±0.5 degrees).

In step S10, the battery 201 is detached from the vehicle body 200a of the electrically powered vehicle 200. First, the processor 11 raises the battery mounting table 34. Thereby, the positioning pin 34a (see FIG. 4) is inserted into the pin insertion hole 208 (see FIG. 5). Further, the locking/unlocking tool 34b (see FIG. 4) is inserted into the tool insertion hole 201f (see FIG. 5). As a result, the battery mounting table 34 is positioned with respect to the electrically powered vehicle 200 (battery 201). At this time, the positioning pin 34a is inserted into the pin insertion hole 208 before the locking/unlocking tool 34b is inserted into the tool insertion hole 201f. The timing at which the positioning pin 34a is inserted into the pin insertion hole 208 and the timing at which the locking/unlocking tool 34b is inserted into the tool insertion hole 201f may be the same.

Next, the processor 11 raises the locking/unlocking tool 34b in a state where the locking/unlocking tool 34b is inserted into the tool insertion hole 201f. Then, the processor 11 drives (rotates) the locking/unlocking tool 34b inserted into the tool insertion hole 201f. Thus, the bolt (not shown) in the tool insertion hole 201f is unlocked. As a result, the battery 201 is detached from the vehicle body 200a. Thus, the battery 201 is mounted on the battery mounting table 34.

In step S11, the battery 201 removed from the vehicle body 200a in step S10 is conveyed to the storage 100b (see FIG. 1). First, the processor 11 lowers the battery mounting table 34 on which the battery 201 is mounted to the height position of the transport unit 36 (see FIG. 1). Thus, the battery 201 is retracted from the vehicle body 200a. Next, the processor 11 lowers the raising/lowering unit 35 (raising/lowering bar 35a) to a position below the battery mounting table 34. Thus, the vehicle body 200a of the electrically powered vehicle 200 is placed on the ground without being held by the raising/lowering bar 35a. Next, the processor 11 drives the roller portion 34c (see FIG. 4) of the battery mounting table 34. Thereby, the battery 201 mounted on the battery mounting table 34 is moved to the Y1 side (the transport unit 36 side) by the roller portion 34c. As a result, the battery 201 is unloaded from the battery mounting table 34. Then, the battery 201 is transported to the temporary placement site 40 by the transport unit 36. Thereafter, the battery 201 is stored in the storage 100b.

In step S12, the processor 11 performs control to attach the new battery 101 to the vehicle body 200a. Specifically, the processor 11 raises the raising/lowering unit 35 (raising/lowering bar 35a). Next, the processor 11 adjusts the position (angle) of the battery mounting table 34 so that the angle in the plan view of the battery mounting table 34 becomes equal to the angle in the plan view of the battery mounting table 34 adjusted in the processing of step S8. At the time of mounting the battery 101, the same processing as in steps S5 to S9 may be performed. In this case, another method may be used to detect the angle θ1.

Next, the processor 11 raises the battery mounting table 34. Thereby, the positioning pin 34a (see FIG. 4) is inserted into the pin insertion hole 208 (see FIG. 5). In this state, the processor 11 raises the locking/unlocking tool 34b. Thus, the locking/unlocking tool 34b is inserted into a tool insertion hole (not shown) of the battery 101. Then, the processor 11 drives (rotates) the locking/unlocking tool 34b. Thus, the bolt (not shown) in the tool insertion hole is locked. When it is detected that all the bolts have been locked, the connector (not shown) of the electrically powered vehicle 200 and the connector (not shown) of the battery 101 are locked. As a result, the mounting of the battery 101 to the vehicle body 200a is completed.

In step S13, the processor 11 lowers each of the battery mounting table 34 and the raising/lowering unit 35. Thus, each of the battery mounting table 34 and the raising/lowering unit 35 is retracted from the electrically powered vehicle 200. Thereafter, the processor 11 closes the shutter 32 (see FIG. 2).

In step S14, the processor 11 notifies the electrically powered vehicle 200 that the battery replacement operation has been completed through the communication unit 13.

In step S23, the electrically powered vehicle 200 receives the notification transmitted from the communication unit 13 of the battery replacement station 100 in step S14. Thus, the electrically powered vehicle 200 is brought into a state in which the ignition power supply can be turned on. Thereafter, the process ends.

As described above, in the first embodiment, the drive device 30 includes the angle adjustment mechanism (34g, 35d) that adjusts the relative angle between the vehicle body 200a and the battery mounting table 34 in the lifted-up state in plan view. Thus, even when the relative angle between the lifted-up vehicle body 200a and the battery mounting table 34 deviates from the reference value (value suitable for battery replacement), the relative angle can be easily corrected.

### Second Embodiment

Hereinafter, a second embodiment of the present disclosure will be described in detail with reference to the drawings. The same components as those in the first embodiment are denoted by the same reference numerals and will not be described repeatedly.

### (Configuration of Battery Replacement Station)

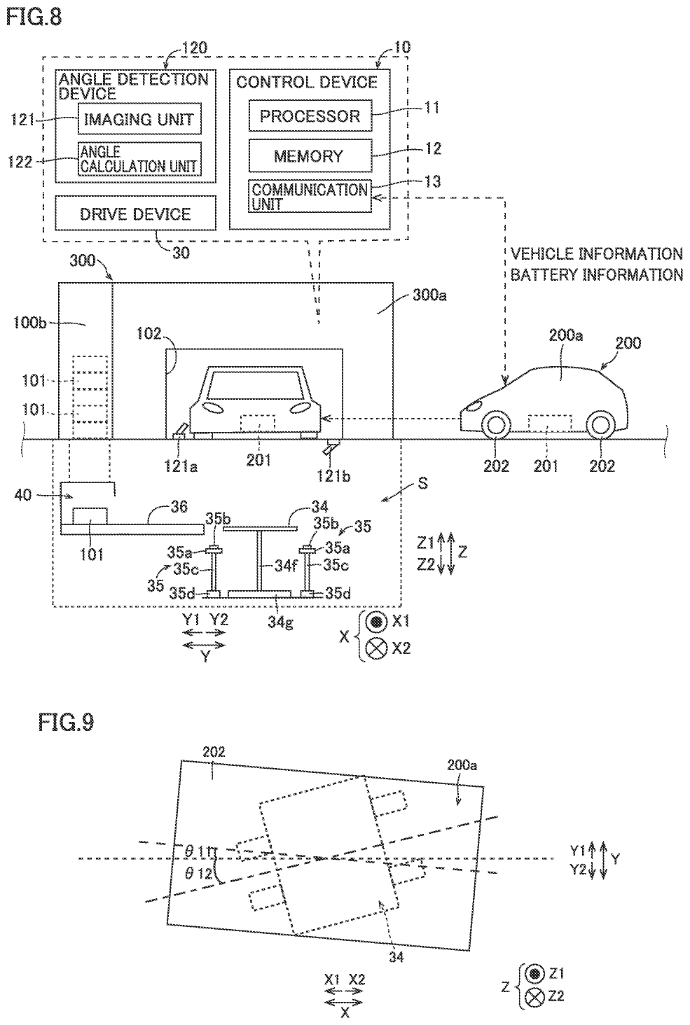

FIG. 8 is a diagram showing a configuration of a battery replacement station 300 according to the second embodiment. The battery replacement station 300 includes a battery replacement apparatus 300a and a storage 100b.

The battery replacement station 300 includes a control device 10, an angle detection device 120, and a drive device 30. The angle detection device 120 is an example of the “relative angle detector” of the present disclosure.

The angle detection device 120 includes an imaging unit 121 and an angle calculation unit 122. The imaging unit 121 includes a camera 121a and a camera 121b. The camera 121a is provided, for example, in the vehicle stop area 103 (see FIG. 2). The camera 121a images the lifted-up vehicle body 200a from below to acquire images of a plurality of markers 201g (see FIG. 5). The angle calculation unit 122 acquires an angle θ11 (see FIG. 9) of the lifted-up vehicle body 200a with respect to the X direction in a plan view based on the images of the plurality of markers 201g acquired by the camera 121a. The X direction is an example of the “predetermined direction” of the present disclosure.

The camera 121b is attached to, for example, the ceiling surface of the underfloor area S. The camera 121b images the battery mounting table 34 from above. The angle calculation unit 122 acquires an angle θ12 (see FIG. 9) of the battery mounting table 34 with respect to the X direction in a plan view based on the image acquired by the camera 121b. In this case, as in the case of obtaining the angle θ11 of the vehicle body 200a, the angle θ12 may be calculated based on images of a plurality of markers (not shown) provided on the battery mounting table 34.

### (Battery Replacement Method)

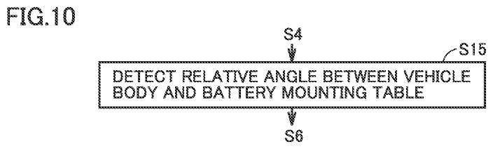

Next, a battery replacement method using the battery replacement station 300 will be described with reference to FIG. 10. In the battery replacement method in the second embodiment, step S15 is performed instead of step S5 in the first embodiment.

In step S15, the angle calculation unit 122 calculates a difference between the angle θ11 (see FIG. 9) and the angle θ12 (see FIG. 9), thereby detecting a relative angle (θ11-θ12) in a plan view between the lifted-up vehicle body 200a and the battery mounting table 34. The other processes (steps) are similar to those of the first embodiment.

In the first and second embodiments, the drive device 30 is controlled based on information about each of the electrically powered vehicle 200 and the battery 201, but the present disclosure is not limited thereto. The drive device 30 may be controlled based on information about either one of the electrically powered vehicle 200 and the battery 201.

In the first and second embodiments, the angle of the vehicle body 200a (and the battery mounting table 34) is detected based on the image of the marker captured by the camera. For example, the angle of the vehicle body 200a and the battery mounting table 34 may be detected using an infrared laser. Further, the angle of the vehicle body 200a may be detected based on the irradiation range of the electrically powered vehicle 200 by the headlamp.

In the above-described first and second embodiments, an example is shown in which an object to be angle-adjusted of the vehicle body 200a and the battery mounting table 34 is switched depending on whether or not the relative angle is larger than the threshold value A (predetermined value), but the present disclosure is not limited thereto. Regardless of the magnitude of the relative angle, an object to be angle-adjusted may be determined in advance for either the vehicle body 200a or the battery mounting table 34.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A battery replacement station provided with a battery that is replaceable with a battery provided in a bottom portion of an electrically powered vehicle, the battery provided in the bottom portion of the electrically powered vehicle being a first battery, the battery provided in the battery replacement station being a second battery, the battery replacement station comprising:
a battery replacement process unit that performs a process of replacing the first battery with the second battery; and
a controller that controls the battery replacement process unit, wherein
the battery replacement process unit includes:
a lift-up mechanism that lifts up a vehicle body of the electrically powered vehicle;
a battery mounting table onto which the first battery removed from the bottom portion of the electrically powered vehicle is to be withdrawn; and
an angle adjustment mechanism that adjusts a relative angle between the vehicle body in a state of being lifted up, and the battery mounting table, in a plan view as seen from above the electrically powered vehicle.

2. The battery replacement station according to claim 1, further comprising a relative angle detector that detects the relative angle, wherein
the angle adjustment mechanism includes a vehicle body adjustment mechanism that adjusts an angle of the vehicle body in the plan view, and
the controller controls the vehicle body adjustment mechanism when the relative angle is larger than a predetermined value.

3. The battery replacement station according to claim 2, wherein
the angle adjustment mechanism includes a mounting table adjustment mechanism that adjusts an angle of the battery mounting table in the plan view, and
the controller controls the mounting table adjustment mechanism when the relative angle is smaller than or equal to the predetermined value.

4. The battery replacement station according to claim 2, wherein
the relative angle detector includes a data acquisition unit that acquires data about the angle of the vehicle body in the plan view, and
the data acquisition unit is installed on the battery mounting table.

5. The battery replacement station according to claim 2, wherein the relative angle detector
detects each of an angle of the vehicle body in the state of being lifted up, with respect to a predetermined direction in the plan view, and an angle of the battery mounting table with respect to the predetermined direction in the plan view, and
detects the relative angle by calculating a difference between the angle of the vehicle body and the angle of the battery mounting table.
